(19) United States
(12) Patent Application Publication
(10) Pub. No.: US 2009/0158654 A1
(43) Pub. Date: Jun. 25, 2009

(54) Flag holder for attachment to a cemetery flower vase

(76) Inventors: Lisa Crane, Henderson, NV (US); Wayne Crane, Lincoln, NE (US)

Correspondence Address: THOMTE LAW OFFICE, L.L.C., 2120 S. 72ND STREET, SUITE 1111, OMAHA, NE, 68124, US

(21) Appl. No.: 12/004,912

(22) Filed: Dec. 21, 2007

(51) Int. Cl. A01G 9/02

(52) U.S. Cl. 47/66.6

(57) ABSTRACT

A flag holder is selectively removably attached to a cemetery flower vase and is adapted to hold one or more flags therein. The flag holder comprises a pair of clamp members which are clamped onto the vase at the lower end thereof with one of the clamp members having holes formed therein adapted to receive the staffs or poles of flags therein.

### BACKGROUND OF THE INVENTION

1. Field of the Invention

This invention relates to a flag holder for use with a cemetery flower vase and more particularly to a flag holder which may be selectively removably attached to a cemetery flower vase.

2. Description of the Related Art

Cemetery flower vases have long been used on cemetery or grave markers. Normally, the flower vases of the prior art have a base portion which is somehow affixed to the marker so that the vase will remain in an upright position but which may be selectively removed from the marker in some instances to permit cemetery maintenance or to permit the vase to be cleaned or replaced. Although the conventional cemetery vases do provide a very good holder for flowers, none of the flower vases of applicants' knowledge include any means for supporting one or more flags thereon. Many people who place flowers in a cemetery vase for memorial purposes will also stick a small flag or the like into the ground near the marker to commemorate the deceased person's military service or for patriotic purposes unrelated to the deceased person's military service.

### SUMMARY OF THE INVENTION

A flag holder is described which may be attached to a cemetery vase and which is adapted to hold one or more flags therein. The flag holder of this invention includes a pair of elongated clamp members which are horizontally disposed and which are placed on either the lower end of the cemetery flower vase or the stem portion of the cemetery flower vase and clamped thereto by means of threaded connectors extending between the clamp members which embrace the vase. One or more flag supports are provided in one of the clamp members into which the staff or pole of the flag may be inserted. The flag holder of this invention may be easily attached to conventional cemetery flower vases without modifying those vases. The flag holder of this invention is adapted to be used on cemetery flower vases which have a stem portion or with those vases which have a tapered or cylindrical body portion extending from the upper end thereof down to the base portion thereof.

It is therefore a principal object of the invention to provide a flag holder for use with a cemetery flower vase.

A further object of the invention is to provide a flag holder which may be attached to a cemetery flower vase and which is adapted to hold one or more flags therein.

A further object of the invention is to provide a flag holder of the type described which is selectively removably attached to the cemetery flower vase.

A further object of the invention is to provide a flag holder which may be clamped onto a cemetery flower vase in a convenient manner.

Still another object of the invention is to provide a flag holder of the type described which is aesthetically pleasing.

These and other objects will be apparent to those skilled in the art.

### BRIEF DESCRIPTION OF THE DRAWINGS

FIG. 1 is a perspective view of the flag holder of this invention clamped onto a cemetery flower vase which is positioned on a grave marker;

FIG. 2 is an exploded perspective view of the flag holder of this invention; and

FIG. 3 is a partial sectional view illustrating the manner in which the clamp members of the flag holder are clamped onto the stem portion of a cemetery flower vase.

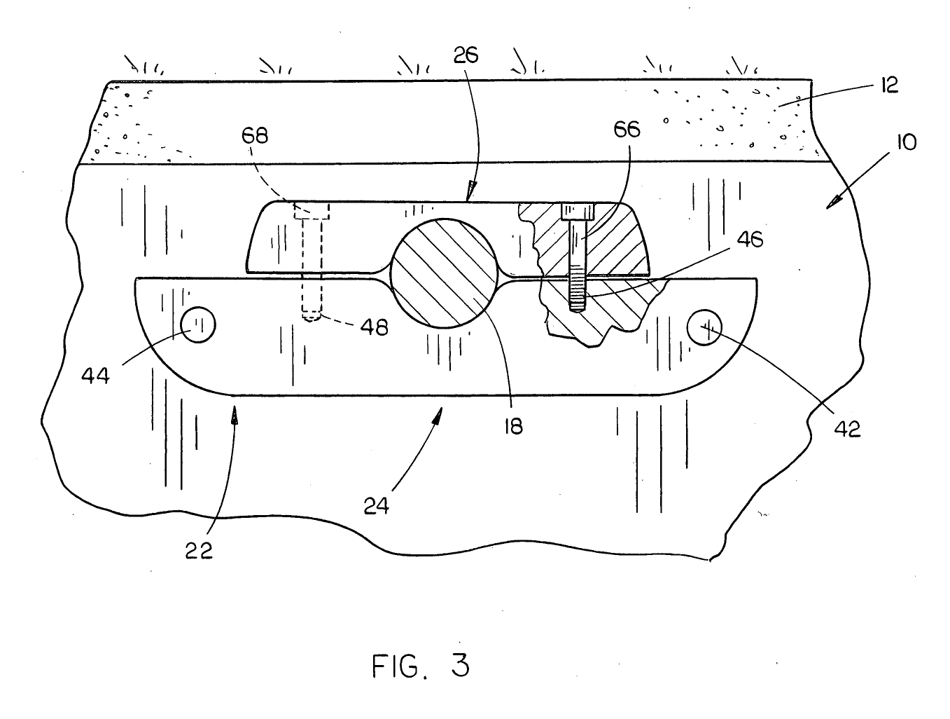

### DESCRIPTION OF THE PREFERRED EMBODIMENT

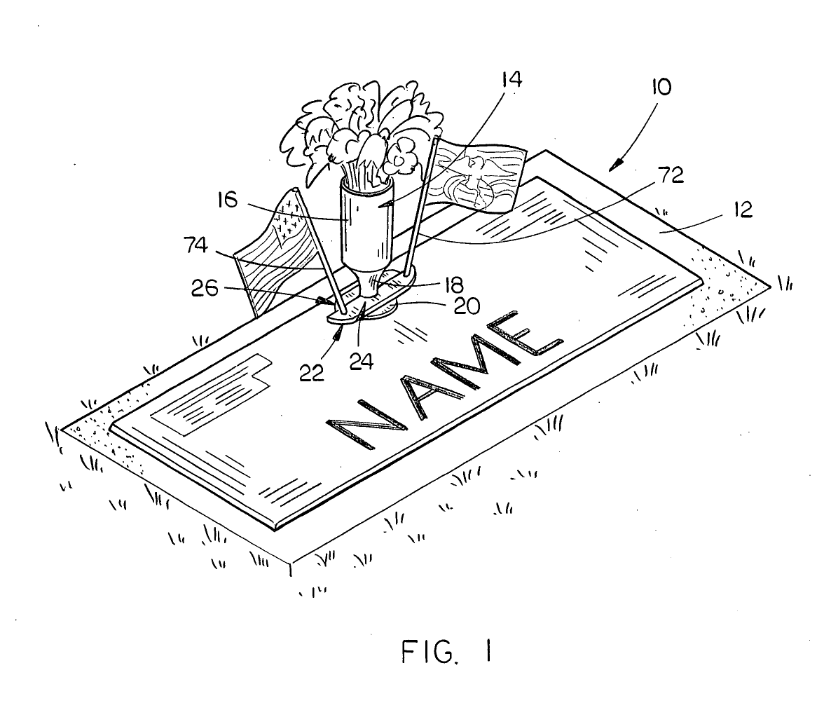

In FIG. 1 the numeral 10 refers to a conventional grave marker found in cemeteries and which is usually embedded in a concrete slab referred to generally by the reference numeral 12. The numeral 14 refers to one type of a conventional cemetery flower vase which is positioned on the marker 10 and which includes a hollow body portion 16 having an open upper end, stem portion 18, and base 20. Base 20 may be secured to the marker 10 in several different ways. In some cases, the base 20 is secured to the marker 10 by screws or anchor bolts. In other cases, the base 20 is received within a mounting ring which is embedded in the marker 10 and which receives the base 20 therein to maintain the vase 14 in its upright position and in a stable manner. Many of the cemetery flower vases 14 include the stem portion 18 but other cemetery flower vases 14 do not utilize a stem portion 18 with the body portion 16 extending all the way down to the base 20 in either a cylindrical fashion or as is in most cases, a tapered fashion. The flag holder of this invention, as will be described hereinafter, is designed to be attached to any type of cemetery flower vase 14 regardless of the manner in which the base 20 is secured to the marker 10 and regardless of whether the vase 14 has a stem portion 18 or not.

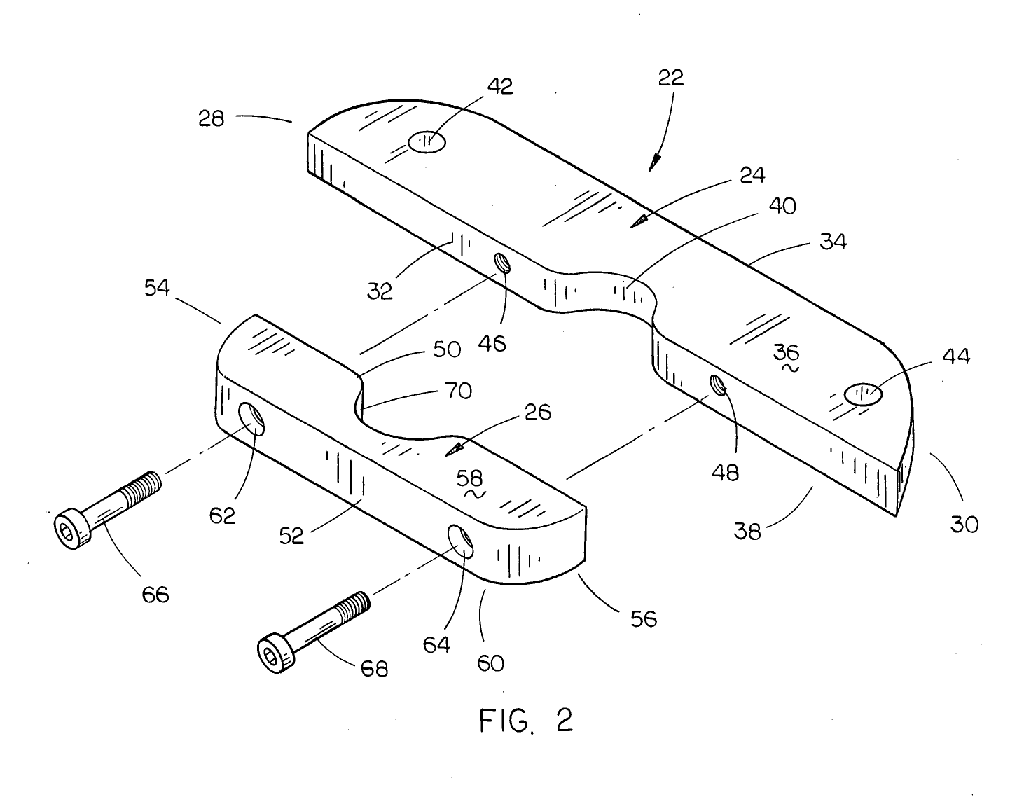

The flag holder of this invention is referred to generally by the reference numeral 22 and is comprised of clamp members 24 and 26. Clamp member 24 includes opposite ends 28 and 30, an inner edge 32 and an outer edge 34. Clamp member 24 also includes a top surface 36 and a bottom surface 38. Clamp member 24 is provided with a generally semi-circular recess 40 formed in its inner edge 32. The size of the recess 40 will depend upon whether the flag holder is to be attached to a cemetery flower vase which has a stem portion 18 or which is simply a cylindrical vase or a tapered vase. Flag support bores 42 and 44 are formed in clamp member 24 and will normally extend completely through clamp member 24 and which preferably extend downwardly and inwardly through clamp member 24. A pair of internally threaded openings 46 and 48 are formed in the inner edge 32 of clamp member 24 as illustrated in FIG. 2. Clamp member 26 includes an inner edge 50, outer edge 52, and opposite ends 54 and 56. Clamp member 26 also includes a top surface 58 and a bottom surface 60. A pair of openings 62 and 64 extend horizontally through clamp member 26 and are adapted to receive the cap screws 66 and 68 therein which may be threadably secured to the internally threaded openings 46 and 48 as will be described hereinafter. The inner edge 50 of clamp member 26 includes a generally semi-circular recess 70 formed therein. The size of the recess 70 will depend on whether the clamp 22 is to be secured to a cemetery flower vase having a stem portion or whether the flower vase is cylindrical or has a tapered configuration.

In use, clamp member 24 will be positioned as illustrated in FIG. 1 so as to be positioned forwardly of the vase 14. Clamp member 26 will be disposed behind the flower vase 14 and the cap screws 66 and 68 will be extended through the openings 62 and 64 respectively and threadably received by the internally threaded openings 46 and 48 in clamp member 26 to securely clamp the flag holder 22 onto the cemetery flower vase 14. Flags 72 and 74 may then be inserted downwardly through the openings 42 and 44 respectively so that the flags will be preferably be angularly disposed as illustrated in FIG. 1.

It can therefore be seen that a novel flag support has been provided which may be attached to a cemetery flower vase in a convenient and stable manner. The flag holder 22 may be secured to cemetery flower vases having different configurations as described above and may be easily attached thereto and easily removed therefrom as desired.

It can therefore be seen that the invention accomplishes at least all of its stated objectives.

We claim:

1. In combination;
a cemetery vase positioned on a grave marker with the vase including a hollow body portion having an open upper end, a closed lower end, and a base at the lower end of the body portion, comprising:
a flag holder attached to the vase which is adapted to hold one or more flags therein.

2. The combination of claim 1 wherein said flag holder is selectively removably attached to the vase.

3. The combination of claim 1 wherein said vase includes a stem portion and wherein said flag holder is attached to the stem portion of the vase.

4. The combination of claim 3 wherein said flag holder is selectively removably attached to the stem portion of the vase.

5. The combination of claim 1 wherein said flag holder is clamped onto the vase.

6. The combination of claim 3 wherein said flag holder is clamped onto the stem portion of the vase.

7. The combination of claim 3 wherein said flag holder is selectively removably clamped onto the stem portion of the vase.

8. The combination of claim 1 wherein said flag holder comprises first and second horizontally disposed, elongated clamp members each of which have first and second ends, a top surface, a bottom surface, an inner side edge, and an outer side edge;
said inner side edges of said first and second clamp members having a generally semi-circular recess formed therein;
said first clamp member having a flag support adjacent its first and second ends; and
connectors selectively securing said clamp members together around the vase.

9. The combination of claim 3 wherein said flag holder comprises first and second horizontally disposed, elongated clamp members each of which have first and second ends, a top surface, a bottom surface, an inner side edge, and an outer side edge;
said inner side edges of said first and second clamp members having a generally semi-circular recess formed therein;
said first clamp member having a flag support adjacent its first and second ends; and
connectors selectively securing said clamp members together around the vase.

10. The combination of claim 8 wherein each of said flag supports comprises a bore extending downwardly into said top surface of said first clamp member.

11. The combination of claim 8 wherein said inner edge of said first clamp member has a pair of internally threaded openings formed therein and wherein screw members extend through said second clamp member into said threaded openings on opposite sides of said generally semi-circular recessed in said first and second clamp members.
